(19) United States
(12) Patent Application Publication
(10) Pub. No.: US 2006/0026010 A1
(43) Pub. Date: Feb. 2, 2006

(54) Computerized cost tracking system

(76) Inventors: Adrianus P.A. van Moorsel, Berlin (DE); Terence Patrick Kelly, Palo Alto, CA (US)

Correspondence Address: HEWLETT-PACKARD COMPANY;Intellectual Property Administration, P.O. Box 272400, Fort Collins, CO, 80527-2400, US

(21) Appl. No.: 10/901,346

(22) Filed: Jul. 29, 2004

(51) Int. Cl. G06Q 99/00

(52) U.S. Cl. 705/1; 705/7

(57) ABSTRACT

A system for tracking costs includes a memory and an application stored in the memory for monitoring costs associated with performing a computational service. The system also includes a controller configured to receive cost information in machine-readable form from one or more input mechanisms. In addition, the controller is configured to execute the application to track the costs associated with performing the computational service.

### BACKGROUND OF THE INVENTION

Network and application service providers, as well as enterprise information technology (IT) departments, operate their systems with increasingly business-oriented goals. For example, service providers are charging per use, and IT departments are being made accountable for the contributions they make to the enterprise's bottom line.

To enable operators to manage their systems so that business objectives are optimized, the cost of equipment, as well as the cost of its usage needs to be tracked. By having cost information readily available, informed business-driven trade-offs may be made to determine whether customers should be accepted, outdated equipment should be replaced or contracts with providers should be modified.

Existing IT operator and administrator tools, however, have no systemic way of specifying and/or monitoring costs associated with delivering a service. Instead, these operator tools focus on measuring and reporting on system performance, but that alone is insufficient for modern-day IT departments. Additionally, tracking costs is necessary in Service Level Agreements (SLAs), which are utilized as management tools to determine which services to provide during times of resource scarcity. SLA's and the associated decision-making process must also be based on cost information, since SLA's with performance objectives alone do not provide an adequate framework to operate as management tools to assist in business-driven decision making.

SLAs are typically established between the service providers and their clients to set forth the terms under which service is to be provided by the service providers. An SLA is a formal contract to, for instance, transport packets of electronic data between customer premise networks (branch offices, data centers, server farms, etc.) across the provider's backbone network with certain assurances on the quality of the transport. The SLA specifies customer expectations of performance in terms of parameters, such as, availability (bound on downtime), delay, loss, priority and bandwidth for specific traffic characteristics. An SLA includes acceptable levels of performance, which may be expressed in terms of response time, throughput, availability (such as 95% or 99% or 99.9%), and expected time to repair.

The SLAs typically establish plans for determining when and the amount service providers are to be paid for services performed. In addition, the SLAs include when and the amount service providers are to be penalized for failing to perform services. The costs associated with payments and penalties are used as management tools to determine which services to perform and which services to forego when resources are scarce. For instance, in a situation where there are insufficient resources to perform all of the services required by an SLA, the decision to forego some of the services is often predicated upon the costs associated with failing to perform those services. In making a decision to forego certain services, a system administrator or other operator often decide to forego services having the lowest cost penalties.

### SUMMARY OF THE INVENTION

According to an embodiment, the present invention pertains to a system for tracking costs. The system includes a memory and an application stored in the memory for monitoring costs associated with performing a computational service. The system also includes a controller configured to receive cost information in machine-readable form from one or more input mechanisms. In addition, the controller is configured to execute the application to track the costs associated with performing the computational service.

### BRIEF DESCRIPTION OF THE DRAWINGS

Features of the present invention will become apparent to those skilled in the art from the following description with reference to the figures, in which:

FIG. 1 is a block diagram of a computing device configured to perform various operations according to examples of the invention;

FIG. 2A is an operational mode for monitoring cost information according to an embodiment of the invention;

FIG. 2B is an operational mode for displaying cost information according to an embodiment of the invention;

FIG. 3 is a block diagram of an automated decision-making system according to an embodiment of the invention;

FIG. 4A is a block diagram of an automated decision-making system according to another embodiment of the invention;

FIG. 4B is a block diagram of an automated decision-making system according to a further embodiment of the invention;

FIG. 5 is a flow diagram of an operational mode of a method for decision-making according to an embodiment of the invention;

FIG. 6 is a flow diagram of an operational mode of a method for decision-making to determine whether resources should be added, according to an embodiment; and

FIG. 7 illustrates a computer system, according to an embodiment of the invention.

### DETAILED DESCRIPTION OF THE INVENTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

According to an embodiment, service or resource cost information may be generated in an explicit form. The service or resource cost information may comprise costs that may arise in performing various services, for instance, costs associated with maintenance, electricity and cooling requirements to keep computers, disk drives, and CPU's powered on, security, depreciation, administration, etc. The service or resource cost information may be included in an electronic document, for instance, an XML description, or other data representation, which is machine-readable. The machine-readable form of the cost information may be employed to, for instance, monitor the costs associated with performing various services. In another example, the cost information may be used as a visualization tool to show, for instance, how costs are being accrued. In a further example, the cost information may be employed by decision-making software in making decisions according to examples of the invention.

With respect to the decision-making example, decisions may be made to perform or forego services during times when resources configured to perform those services exceed demand for those resources. Service Level Agreements (SLAs) and various resource costs may form factors employed in making those decisions. By way of example, the decision-maker, for instance, network administrator, operator, management, etc., or computer system making those decisions may decide to forego certain services if the costs associated with failing to perform those services (penalties) as set forth in the SLAs are less than the resource costs associated with performing those services. In addition, the decision-maker may also decide to forgo performance of those services if the payments set forth in the SLAs are less than the resource costs associated with performing those services.

In one example, an explicit description of the service or resource cost information is provided in systems configured to manage performance of services. In another example, an explicit description of the service or resource cost information is provided in systems configured to make decisions in information technology (IT) systems. The service or resource costs may also be classified into different categories. The different categories of service or resource costs may be afforded various weight factors, which may range from, for instance, no relevance to absolute relevance. In this regard, the service or resource costs having a certain degree of relevance may be relatively more important in the decision-making process in comparison with those costs which are considered to have no or minimal relevance.

In another example, a visualization or representation of the service or resource costs in a software tool is provided for managing IT systems. The software tool may be implemented to guide, for instance, capacity planning decisions. As an example, the software tool may display the marginal value of additional resource units, for instance, the marginal value of additional CPU's or storage capacity, which may be used in determining whether additional resource units should be purchased.

The explicit descriptions of the service or resource cost information may be annotated to the respective managed objects. Thus, a machine-readable description of the operating requirements, for instance, an XML file describing the objects' electrical demands and thermal output, may be included with the objects. In one regard, the operating requirements may be “bundled” with the product, for instance, a computer system, storage system, PA-RISC CPU, etc. The machine readable description stored in this manner may enable automated decision-making software to locate this information in a relatively simple manner.

Through implementation of various examples of the invention, the utilization of resources by a provider of services may be monitored through the costs associated with providing the services. The monitoring of the costs may also be displayed as a visualization tool for users or other personnel of the service provider. In addition, a framework in determining which services to perform and which services to forego is provided. The framework generally includes factors relevant to the decision making process. These factors are taken into account to maximize profits and to therefore minimize penalties. In one regard, the framework may be implemented as a management tool to utilize resources and manage costs in substantially optimized manners.

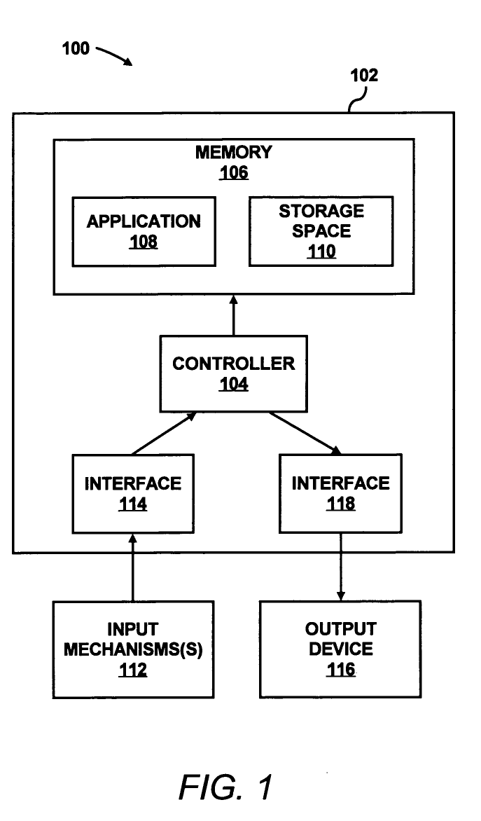

Referring first to FIG. 1 there is shown a block diagram 100 of a computing device 102 configured to perform various operations according to examples of the invention. The block diagram 100 represents a simplified depiction of the computing device 102. As such, additional components may be added or the components of the computing device 102 may be modified or removed without departing from a scope of the invention.

The computing device 102 may comprise a desktop computer, a laptop computer, a server, a portable digital assistant, etc. The computing device 102 may include a controller 104 configured to control operations of the computing device 102. The controller 104 may thus comprise, for instance, a microprocessor, a micro-controller, an application specific integrated circuit (ASIC), and the like. In performing various applications of the computing device 102, the controller 104 may access software or other algorithms stored in a memory 106. The memory 106 may be implemented, for instance, as a combination of volatile and non-volatile memory, such as DRAM, EEPROM, flash memory, and the like.

The memory 106 is depicted as including application 108. A single application 108 is illustrated for purposes of simplicity. It should, however, be understood that the memory 106 may include any number of various types of applications that the controller 104 may implement in the operations of the computing device 102. Thus, although the following description discusses the use of the application 108 as performing various operations, any number of applications may be used to perform these operations without departing from a scope of the computing device 102 depicted in FIG. 1. The memory 106 is also illustrated as including a storage space 110 for storing information.

The computing device 102 may include a secondary memory (not shown) that includes, for example, one or more hard disk drives and/or a removable storage drive, representing a floppy diskette drive, a magnetic tape drive, a compact disk drive, etc., where a copy of the application 108 may be stored. The removable storage drive may read from and/or write to a removable storage unit, such as a floppy diskette, compact disk, magnetic tape, etc., in a well-known manner. The removable storage unit may comprise a computer readable medium on which a copy of the application 108 is stored.

In one example, the application 108 may comprise software or an algorithm configured to monitor costs, for instance, maintenance, electricity and cooling requirements to keep computers operational, disk drives, and CPU's powered on, security, depreciation, administration, etc., associated with performing various services. The controller 104 may operate the application 108 to track, for instance, electrical demands and thermal outputs of resources, for instance, computer systems, storage systems, disk drives, cooling systems, etc., used to perform the various services. The electricity and cooling requirements may include those costs associated with operating the resources to perform the various services. Thus, for instance, the amount of electricity required to operate the resources as well as to maintain their temperatures within predetermined ranges may be related to the electricity costs in general to obtain a monetary figure. By way of example, if 1 kW of electricity costs X dollars and it is known that 10 kW of power is required to perform a service, the electricity costs may be considered as equaling 10× dollars. Other types of costs, such as, maintenance, security, depreciation, etc., are described in greater detail hereinbelow.

One or more input mechanisms 112 may be employed to input the information pertaining to the electrical demands and the thermal outputs of the resources, and the cost per unit of power into the computing device 102. In addition, communications from the input mechanism(s) 112 may be directed through an interface 114. The interface 114 may comprise drivers or other hardware/software for enabling the information to be communicated and understood by the controller 104. The input mechanism(s) 112 may comprise devices designed for use as input devices for the computing device 102. These devices may include, for instance, a keyboard, a mouse, a disk drive, etc. In addition or alternatively, the input mechanism(s) 112 may comprise the resources or, for instance, another computing device configured to collect the electrical demand and thermal output information. In any case, the information pertaining to the electrical demand and thermal output information of the resources may be stored in the storage space 110.

In one regard, the electrical demands and thermal outputs may be stored in machine-readable form, such as, for instance, in XML language. In addition, the costs pertaining to various amounts of power required to operate the resources may also be stored in the storage area 100 in machine-readable form. Thus, in performing the application 108, the controller 104 may have access to the power requirements of the resources, both in terms of operational electricity costs and cooling costs, and the costs per unit of power. Through determination of the power requirements of the resources, the controller 104 may monitor the costs associated with the performance of various services with those resources.

The costs associated with operating the resources may vary based upon, for instance, the time of day when the resources are being operated. By way of example, per unit costs for power may vary at various times during the day. The application 108 may be configured to update the per unit of power costs stored in the storage space 110 to reflect the changing power costs. In one example, an input mechanism 112 may comprise a device to track the power costs, which may be supplied to the computing device 102. In another example, if the vary the same amount each day, the power costs stored in the storage space 110 may be configured to also vary according to the actual power cost changes.

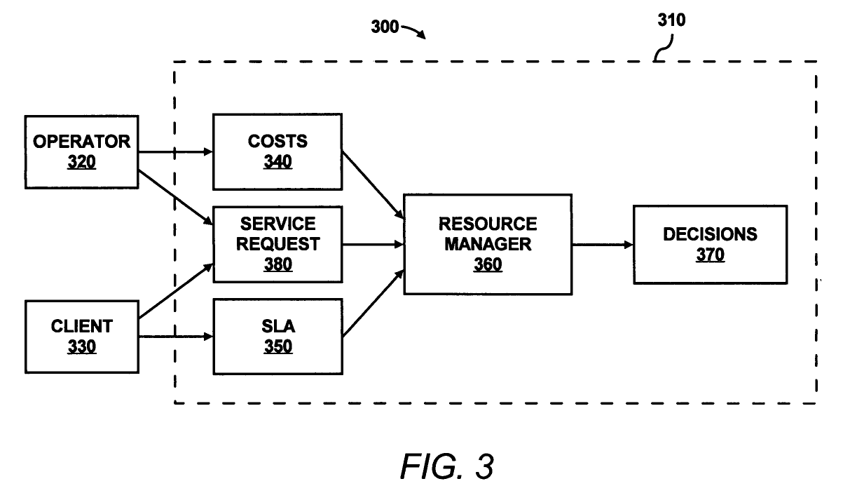

The application 108 may also be configured to parameterize the costs associated with the performance of various services. For instance, the application 108 may distinguish which resources are being operated for the performance of which services. In this regard, the application 108 may monitor the costs associated with the performance of individual services. The application 108 may receive this information from, for instance, a resource manager (shown in FIG. 3) configured to control which resources are operated to perform the services.

The controller 104 may also communicate or otherwise send signals to an output device 116. In addition, communications from the controller 104 to the output device 116 may be directed through an interface 118. The interface 118 may comprise drivers or other hardware/software for enabling information to be communicated and understood by the output device 116. In one respect, the output device 116 may comprise a monitoring tool configured to collect data regarding the network and system performances of the service provider. The controller 104 may be configured to transmit cost information through operation of the application 108 to the monitoring tool. In addition, the monitoring tool may initiate probes to monitor the costs.

In another example, the output device 116 may comprise a display or other device capable of supplying information to a user, for instance, an audible alarm, a visual indicator, etc. In this example, the controller 104 may signal the output device 116 to activate if the costs for performing a service exceed a threshold. In the instance that the output device 116 comprises a display, the activation of the display may include an indication on the display. If the output device 116 comprises the other device described above, the activation may include an audio indication or a visual indication, such as, a blinking light. The threshold may be set based upon one or more of a plurality of factors. For instance, the threshold may be based upon a penalty amount or a payment amount set forth in a service level agreement (SLA) (depicted in FIG. 3). By way of example, the output device 116 may be activated if the costs associated with performing a service is near an amount equal to or a predetermined level below the penalty amount set forth in the SLA. In this regard, a user may be alerted when the costs associated with performing a service is near the penalty amount.

According to another example, the application 108 may comprise software or an algorithm configured to enable visualization of the costs associated with performing various services. In this example, the output device 116 may comprise a display device configured to display the costs. The costs may be displayed, for instance, graphically, in tabular form, three-dimensional modeling, etc. By way of example, the application 108 may be configured to display a correlation between the use of various resources to perform various services. In addition, the application 108 may be configured to vary the display as correlations between the costs and resource usage varies. In this regard, a user may identify, for instance, the costs associated with the performance of respective services in a relatively simple and efficient manner.

In this example, the application 108 may also be configured to alert a user to situations in which the costs for performing various services is near the penalty amount set forth in the SLA. In addition, the application 108 may be configured to display, for instance, a tracking of the costs with respect to the penalty amount in the SLA. In this case, the application 108 may operate the output device 116 to display the penalty amount and the costs associated with performing the various services. In addition, the application 108 may cause an alert to be displayed on the output device 116 in the event that the costs are near the penalty amount.

According to a further example, the application 108 may operate as a resource manager (depicted as element 360 in FIG. 3). In this example, the application 108 may operate to make decisions on whether to perform or forego performance of various services based upon the costs associated with performing those services and the penalty amounts set forth in the SLAs. A more detailed discussion of this example is set forth with respect to FIGS. 3-6.

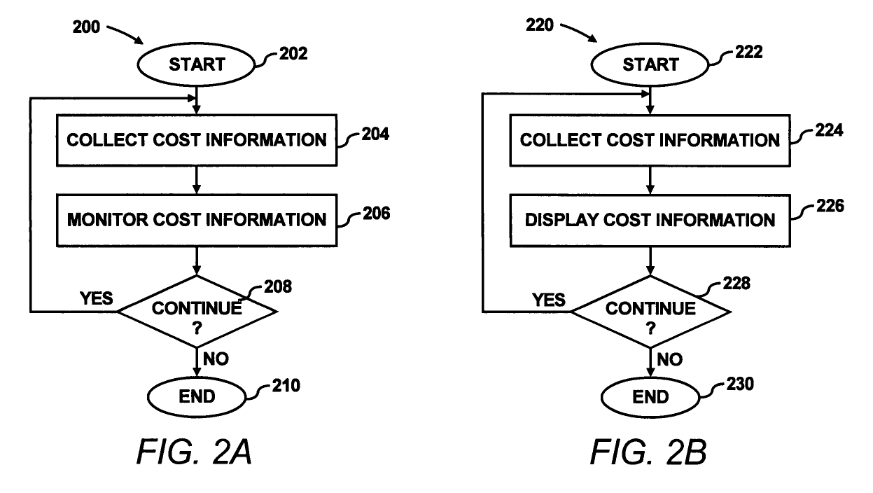

With reference now to FIG. 2A, there is shown an operational mode 200 for monitoring cost information according to an embodiment of the invention. The following description of the operational mode 200 is but one manner of a variety of different manners in which cost information may be monitored according to this embodiment. In addition, the operational mode 200 represents a generalized illustration and thus other steps may be added or existing steps may be removed, modified or rearranged without departing from a scope of this embodiment.

The description of the operational mode 200 is made with reference to the block diagram 100 illustrated in FIG. 1, and thus makes reference to the elements cited therein. It should, however, be understood that the operational mode 200 is not limited to the elements set forth in the block diagram 100. Instead, it should be understood that the operational mode 200 may be practiced by computing devices having different configurations than those set forth in the block diagram 100.

As shown, at step 202, the operational mode 200 may be started or initiated. The operational mode 200 may be started in a variety of manners. For instance, the operational mode 200 may be started manually by a user or the operational mode 200 may be programmed to start automatically through receipt of a service request, at various times, etc. In addition, starting of the operational mode 200 activates the application 108. Once initiated, cost information pertaining to the resources employed to perform the various services may be collected at step 204. As described hereinabove, the cost information may pertain to the electrical requirements, thermal outputs, maintenance, security, and other costs associated with operating the resources to perform the various services. In addition, the cost information may include the price for the power required to perform the various services, which may vary over time.

At step 206, the controller 104 may run the application 108 to monitor the cost information. Thus, for instance, the controller 104 may track how resources are being utilized and determine the costs associated with the use of those resources. In one example, the controller 104 may also be configured to compare those costs with penalty amounts specified in SLAs as described hereinabove. In addition, the controller 104 may be configured to provide an alert through the output device 116 when, for instance, those costs near the penalty amounts.

At step 208, the controller 104 may determine whether the operational mode 200 is to continue. The controller 104 may continue the operational mode 200 if the controller 104 is configured to, for instance, continuously monitor the cost information. If the operational mode 200 is to continue, then steps 204-208 may be repeated any number of times until it is determined that the operational mode 200 is to end. If the controller 208 is configured to perform a single monitoring operation or if the controller 208 has performed a final monitoring operation of a number of monitoring operations, the controller 104 may end the operational mode 200 as indicated at step 210.

With reference now to FIG. 2B, there is shown an operational mode 220 for displaying cost information according to an embodiment of the invention. The following description of the operational mode 220 is but one manner of a variety of different manners in which cost information may be displayed according to this embodiment. In addition, the operational mode 220 represents a generalized illustration and thus other steps may be added or existing steps may be removed, modified or rearranged without departing from a scope of this embodiment.

The description of the operational mode 220 is made with reference to the block diagram 100 illustrated in FIG. 1, and thus makes reference to the elements cited therein. It should, however, be understood that the operational mode 220 is not limited to the elements set forth in the block diagram 100. Instead, it should be understood that the operational mode 220 may be practiced by computing devices having different configurations than those set forth in the block diagram 100.

As shown, the operational mode 220 may be started or initiated at step 222. The operational mode 220 may be started in a variety of manners. For instance, the operational mode 220 may be started manually by a user or the operational mode 220 may be programmed to start automatically through receipt of a service request, at various times, etc. In addition, starting of the operational mode 220 activates the application 108. Once initiated, cost information pertaining to the resources employed to perform the various services may be collected at step 224. As described hereinabove, the cost information may pertain to the electrical requirements, thermal outputs, maintenance, security, and other costs associated with operating the resources to perform the various services. In addition, the cost information may include the price for the power required to perform the various services, which may vary over time.

At step 226, the controller 104 may run the application 108 to display the cost information. Thus, the controller 104 may operate the output device 116 to display, for instance, how and where resources are being utilized and the costs associated with their use. In one example, the controller 104 may also be configured to compare those costs with penalty amounts specified in SLAs as described hereinabove. In addition, the controller 104 may be configured to control the output device 116 to display the costs and penalty amounts to generally enable a user to view the costs and penalty amounts in a relatively simple manner.

At step 228, the controller 104 may determine whether the operational mode 220 is to continue. The controller 104 may continue the operational mode 220 if the controller 104 is configured to, for instance, continuously display the cost information. If the operational mode 220 is to continue, then steps 224-228 may be repeated any number of times until it is determined that the operational mode 220 is to end. In one regard, the display of the cost information at step 226 may vary as the cost information collected at step 224 varies. Therefore, the cost information may be substantially continuously updated to reflect changing costs. If the controller 104 is configured to perform a single monitoring operation or if the controller 104 has performed a final monitoring operation of a number of monitoring operations, the controller 104 may end the operational mode 220 as indicated at step 230.

The monitoring operation of the operational mode 200 and the displaying operation of the operational mode 220 may be performed substantially concurrently and may form part of the same program. In this regard, the cost information may be monitored and display substantially concurrently.

Referring to FIG. 3, there is shown a block diagram 300 of an automated decision-making system 310 according to an embodiment. As shown, an operator 320 interacts with the system 310. The operator 320 may include a system administrator, CFO, technician, or other person capable of providing cost input. A client 330 is also shown as interacting with the system 310. The client 330 may include any end-user capable of entering into an SLA with a service provider.

The operator 320 is illustrated as communicating costs 340 to the system 310. The costs 340 may include costs associated with maintenance, electricity and cooling requirements to keep computers, disk drives, and CPU's powered on, security, depreciation, administration, etc. The costs 340 may, for instance, include costs associated with performing various services. By way of example, if the service to be performed is a relatively large animation rendering application for a digital animation studio, the costs 340 may be associated with the various factors described hereinabove. More particularly, the operator 320 may determine that a particular number of computers running for a particular amount of time are required in order to perform the desired service. The costs associated with the maintenance required to operate the computers for the particular amount of time may be included in the costs 340. In addition, the costs associated with the electricity in operating the computers as well as the costs associated with cooling the computers may also be included in the costs 340. The costs associated with cooling the computers may include, for instance, the costs associated with operating the cooling system components, for instance, air conditioner units, etc.

The client 330 is illustrated as communicating an SLA 350 to the system 310. More particularly, the client 330 enters into an SLA 350 with the service provider. In the SLA 350, various terms are explicitly agreed upon as described hereinabove. The terms of the SLA 350 generally include payments for services performed and penalties for failure to perform the services. In keeping with the example above, the SLA 350 may include a payment due to the service provider once the animation rendering application is performed. In addition, the SLA 350 may include a penalty for failing to perform the service, for instance, within a predetermined amount of time.

Information pertaining to the costs 340 and the terms of the SLA 350 are illustrated as being inputted into a resource manager 360. The resource manager 360 may comprise a computer system or, more basically, a controller, for instance, a microprocessor, a micro-controller, an application specific integrated circuit (ASIC), and the like, and a memory. The resource manager 360 may also include software operating on a computing platform programmed to analyze the various inputs received as costs 340 and the SLA 350. In any regard, the resource manager 360 may be configured to output decisions 370 based upon the information pertaining to costs 340 and the terms of the SLA 350. The information pertaining to the costs 340 and the SLA terms 350 may be in the form of machine-readable language, for instance, XML files, to thus enable the resource manager 360 to comprehend the costs 340 and the SLA terms 350.

In a general sense, the resource manager 360 compares the costs 340 and the terms in the SLA 350 in making the decisions 370 to perform various services. For instance, the resource manager 360 may decide to perform a service if the payments stated in the SLA 350 are greater than the costs 340 associated with performing the service. As another example, the resource manager 360 may decide not to perform a service if the costs 340 exceed the penalties stated in the SLA 350. In this case, it would be more cost-effective to accept the penalties for failing to perform the service rather than incurring the costs associated with performing the service. Thus, in the animation studio example above, the resource manager 360 may decide to forego performance of the animation rendering application if the costs associated with its performance exceed the penalties associated with failing to provide the perform the service. The decision to perform various services may therefore be predicated upon substantial optimization of benefits to the service provider.

In operation, the resource manager 360 may receive a service request 380. The service request 380 may comprise any number of various services known to be performed by service providers. As illustrated in FIG. 3, the service request 380 may be provided to the resource manager 360 from either or both the operator 320 and the client 330. Once the resource manager 360 receives the service request 380, the resource manager 360 may determine the costs 340 associated with performing the requested service 380. The resource manager 360 may also determine the payments and/or penalties also associated with the requested service 380. As described hereinabove, if the costs 340 are greater than either of the payments or penalties, the resource manager 360 may make a decision 370 to forego performance of the requested service 380. Otherwise, the resource manager 360 may make a decision 370 to perform the requested service 380.

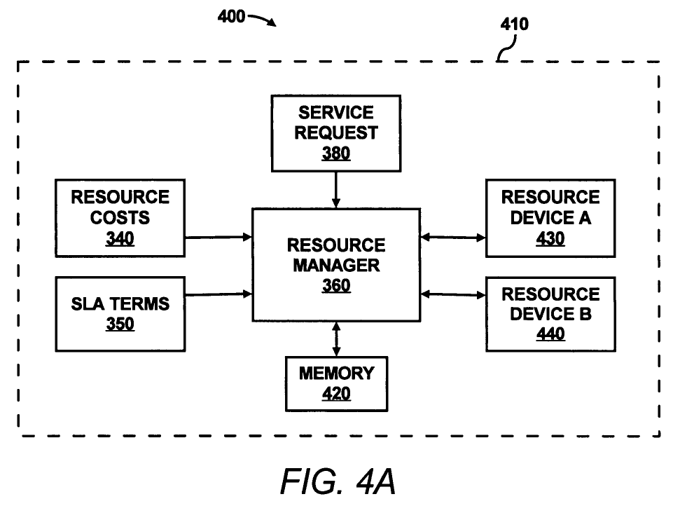

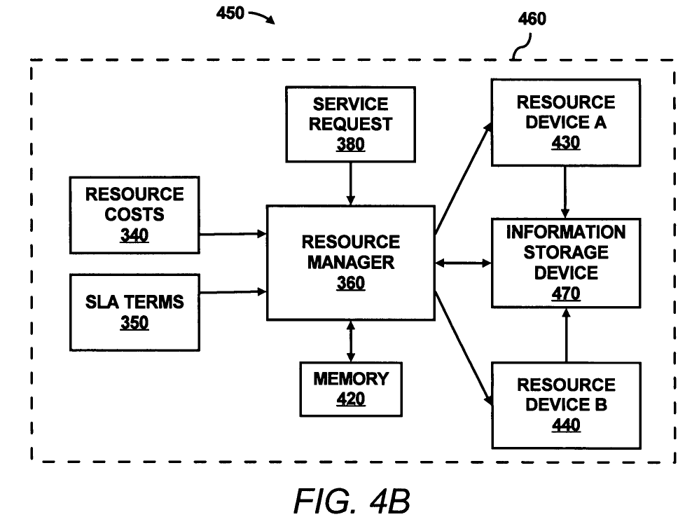

FIG. 4A illustrates a block diagram 400 of an automated decision-making system 410 according to another embodiment. It should be understood that the following description of the block diagram 400 is but one manner of a variety of different manners in which such a decision-making system 410 may be configured. In addition, it should be understood that the decision-making system 410 may include additional components and that some of the components described herein may be removed and/or modified without departing from the scope of the invention. For instance, the decision-making system 410 may include any number of resource devices, resource managers, as well other components, which may be implemented in the operations of the decision-making system 410.

As shown, the decision-making system 410 includes the resource costs 340 and SLA terms 350 as inputs to the resource manager 360 as described hereinabove with respect to the system 310. In addition, the system 410 includes a memory 420 associated with the resource manager 360. The memory 420 may be implemented, for instance, as a combination of volatile and non-volatile memory, such as DRAM, EEPROM, flash memory, and the like. In addition, although the memory 420 is illustrated as comprising a separate entity from the resource manager 360, the memory 420 may be integrated with the resource manager 360 without departing from the scope of the invention.

FIG. 4A also illustrates a resource device A 430 and a resource device B 440. The resource devices 430 and 440 may comprise devices for performing requested services. In this regard, the resource devices 430 and 440 may comprise, for instance, computers, servers, disk drives or other storage systems, PA-RISC CPU's, etc. The resource devices 430 and 440 may be interfaced with the resource manager 360 through, for instance, a wired or wireless protocol in generally known manners. In one example, the resource devices 430 and 440 may include a machine-readable description of their operating requirements. For instance, the resource devices 430 and 440 may include an XML file with a description of its electrical demands and thermal outputs. In general, therefore, the machine-readable descriptions of the operating requirements of the resource devices 430 and 440 may be embedded in resource devices 430 and 440.

The operating requirements may be communicated to the resource manager 360, which may store this information in the memory 420. In addition, this type of communication may be performed, for instance, when the resource devices 430 and 440 are installed or when the resource devices 430 and 440 are updated or upgraded. Otherwise, the communication of information from the resource devices 430 and 440 to the resource manager 360 may be performed in response to a query for the information by the resource manager 360. The operating requirements of the resource devices 430 and 440 may be designated by the manufacturers of the resource devices 430 and 440. Alternatively, the operating requirements may be determined through testing of the resource devices 430 and 440 and may be embedded, for instance, in the driver software in the case of disks and storage arrays.

The resource manager 360 may therefore relatively easily determine, for instance, the costs associated with operating the resource devices 430 and 440 and with cooling the resource devices 430 and 440. For instance, the resource manager 360 may receive information pertaining to the electricity costs per kW and determine the costs associated with operating the resource devices 430 and 440 based upon their electrical demands and thermal outputs. The resource manager 360 may employ these factors along with other costs, for instance, maintenance, depreciation, security, administration, etc., in making determinations of the costs associated with performing a service. In addition, the resource manager 360 may compare the costs associated with performing the requested service 380 with the costs associated with the penalty for failing to perform the service.

FIG. 4B illustrates a block diagram 450 of an automated decision-making system 460 according to another embodiment. The system 460 is similar to the system 410 and thus contains features similar to those described hereinabove with respect to the system 410. Therefore, only those features that differ from the system 410 are described in detail hereinbelow for purposes of brevity.

As illustrated in FIG. 4B, the decision-making system 460 includes an information storage device 470 interfaced with the resource devices 430 and 440. The information storage device 470 may comprise an electronic document, for instance, an XML description, configured to store machine-readable information obtained from, for instance, the resource devices 430 and 440. The information storage device 470 may be stored in a memory, for instance, the memory 420 or the information storage device 470 may comprise a separate storage unit. In any regard, information pertaining to the operating requirements, for instance, the electrical demands, thermal output, etc., of the resource devices 430 and 440 may be stored in the information storage device 470.

As shown, the information storage device 470 is configured to directly receive operating requirement information from the resource devices 430 and 440. In this instance, the information storage device 470 may be interfaced with the resource devices 430 and 440 in any reasonably suitable known wired or wireless manner. Information from the resource devices 430 and 440 may be communicated to the information storage device 470 when the resource devices 430 and 440 are installed, updated or upgraded, or the information may be communicated through an instruction from the resource manager 360, the information device 470 or a user.

In addition, or alternatively, the information storage device 470 may comprise an independent unit that may receive information directly from a user. In this instance, the operating requirement information may be directly input through, for instance, a keyboard, a mouse, or a recordable medium (for instance, a floppy disk, a compact disk, etc.). Again, the operating requirement information may be supplied by the manufacturers or they may be determined through testing as described hereinabove.

The information storage device 470 is illustrated as being interfaced with the resource manager 360. In this regard, the resource manager 360 may obtain operating requirement information pertaining to operation of the resource devices 430 and 440 from the information storage device 470. In addition, as also described hereinabove, the resource manager 360 may employ this information in determining whether to perform or forego performance of a requested service.

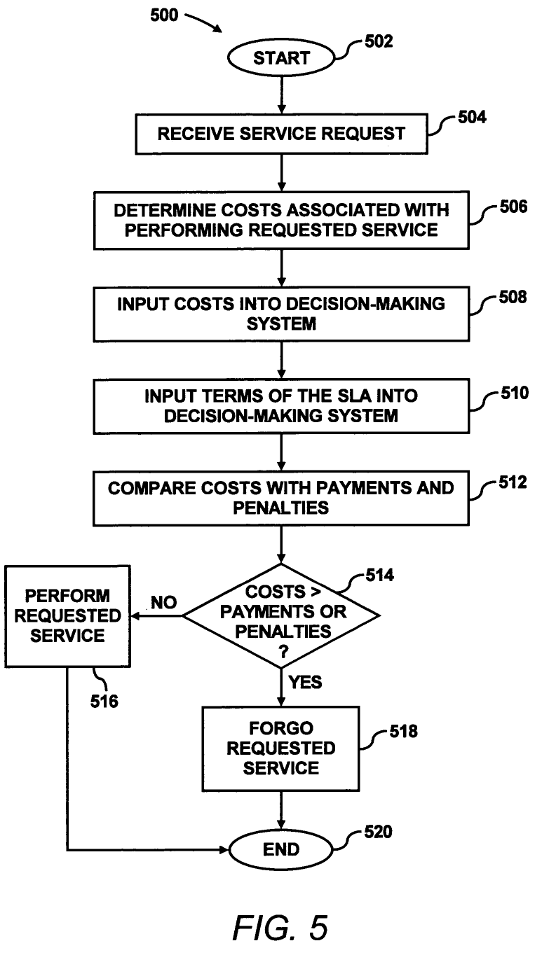

With reference now to FIG. 5, there is shown a flow diagram of an operational mode 500 of a method for decision-making according to an embodiment. It is to be understood that the following description of the operational mode 500 is but one manner of a variety of different manners in which an embodiment of the invention may be practiced. It should also be apparent to those of ordinary skill in the art that the operational mode 500 represents a generalized illustration and that other steps may be added or existing steps may be removed, modified or rearranged without departing from the scope of the invention.

The description of the operational mode 500 is made with reference to the block diagrams 400 and 450 illustrated in FIGS. 4A and 4B, respectively, and thus makes reference to the elements cited therein. It should, however, be understood that the operational mode 500 is not limited to the elements set forth in the block diagrams 400 and 450. Instead, it should be understood that the operational mode 500 may be practiced by decision-making systems having different configurations than those set forth in the block diagrams 400 and 450.

The operational mode 500 may be initiated in response to a variety of stimuli at step 502. For example, a user may manually initiate the operational mode 500, the operational mode 500 may be initiated in response to a service request, etc. At step 504, a service request 380 may be received by the resource manager 360. As stated hereinabove, the service request 380 may be transmitted to the resource manager 360 from the operator 320 or the client 330.

At step 506, the costs associated with performing the requested service 380 may be determined. The costs may comprise the costs 340 and may include a plurality of factors. The costs 340 may include, for instance, costs associated with maintenance, electricity and cooling requirements to keep computers, disk drives, and CPU's powered on, security, depreciation, administration, etc. More particularly, maintenance costs may pertain to the costs associated with maintaining the resource devices 430, 440 operational and may include installation of upgrades, performing diagnostic tests, and other costs known to be associated with maintaining components configured to perform services provided by service providers.

Security costs may include, for instance, costs associated with maintaining certain levels of security as dictated by the SLA. By way of example, the SLA may stipulate that the service provider institute a certain level of security in performing services for the clients. This may entail purchase or implementation by the service provider of additional hardware and/or software to achieve the desired security levels. The administration costs may include, for instance, the costs associated with overseeing the operations of the resource devices 430 and 440 in performing the requested service 380. By way of example, the administration costs may include utilization of personnel or software to oversee that the requested service 380 is being performed properly. These costs may also be considered when making a determination of the costs associated with performing the requested service.

The electricity and cooling requirements may include those costs associated with operating these components to perform the requested services. Thus, for instance, the amount of electricity required to operate these components as well as to maintain their temperatures within predetermined ranges may be related to the electricity costs in general to obtain a monetary figure. By way of example, if 1 kW of electricity costs X dollars and it is known that 10 kW of power is required to perform the requested service 380, the electricity costs may be considered as equaling 10× dollars. The operating requirements, for instance, electrical demands and thermal output, may be received by the resource manager 360 from the resource devices 430 and 440 in various manners as described hereinabove with respect to FIGS. 4A and 4B.

Some of the costs associated with performing the requested service 380 may not be included as factors affecting the decision of the resource manager 360. Generally speaking, these costs may be considered as “sunk costs”. “Sunk costs” may include, for instance, costs incurred by a service provider, but which are not directly related to the costs associated with performing the various services. For instance, a sunk cost may be the cost of real estate on which a data center is located. As another example, the costs associated with creating the hardware infrastructure on which computations are formed may be considered as an unrecoverable past expense and therefore a sunk cost.

The costs associated with performing the requested service 380 may be compiled into a file having a machine-readable format, for instance, an XML file. The file may, for instance, be in the form of a look-up table or some other manner of organizing the cost information. At step 508, the information from the file or the file itself may be input into the decision-making system, which, according to an example of the invention, is the resource manager 360. As described in greater detail hereinabove, some or all of the cost information may be input by an operator 320 or from the resource devices 430, 440. In the case of the resource devices 430, 440, the cost information may be either directly transmitted to the resource manager 360 or through an information storage device 470.

In addition, at step 510, the terms of the SLA 350 may also be input into the decision-making system, for instance, the resource manager 360. The terms of the SLA 350 may be converted into machine-readable language, such that the resource manager 360 may interpret the SLA terms 350. In addition, the resource manager 360 may receive the terms of the SLA 350 such that the resource manager 360 may be able to determine the costs associated with payments for performing a requested service 380 and penalties for failing to perform the requested service 380. In this regard, the resource manager 360 need not receive all of the terms contained in the SLA 360. Instead, the resource manager 360 may be supplied with substantially only information relevant to the decision with respect to the requested service 380. Thus, for instance, the payments and the penalties may be supplied to the resource manager 360 without substantially all of the other information typically found in conventional SLAs.

At step 512, the resource manager 360 may compare the costs 340 with the payments or penalties as set forth in the SLA terms 350. More particularly, the resource manager 360 may determine whether the costs exceed the payments or penalties at step 514. If the costs 340 are lower than the payments or penalties, the resource manager 360 may decide to perform the requested service 380 at step 516. In one example, the resource manager 360 may operate to control the resource devices 430 and 440. In this regard, the resource manager 360 may function as a controller for the resource devices 430 and 440 to operate the resource devices 430 and 440 to perform the requested service 380. In another example, the resource manager 360 may instruct a controller of the resource devices 430 and 440 to perform the requested service 380. In any respect, the resource devices 430 and 440 may be operated to perform the requested service 380 under any reasonably suitable conventional manner.

Referring back to step 514, if the costs exceed the either the payments or the penalties, the resource manager 360 may decide to forego performing the requested service 380 as indicated at step 518.

Following either of steps 516 or 518, the operational mode 500 may end as indicated at step 520. Step 520 may function as an idle mode as the operational mode 300 may be reactivated, for instance, when the resource manager 360 receives another service request, manually initiated, etc.

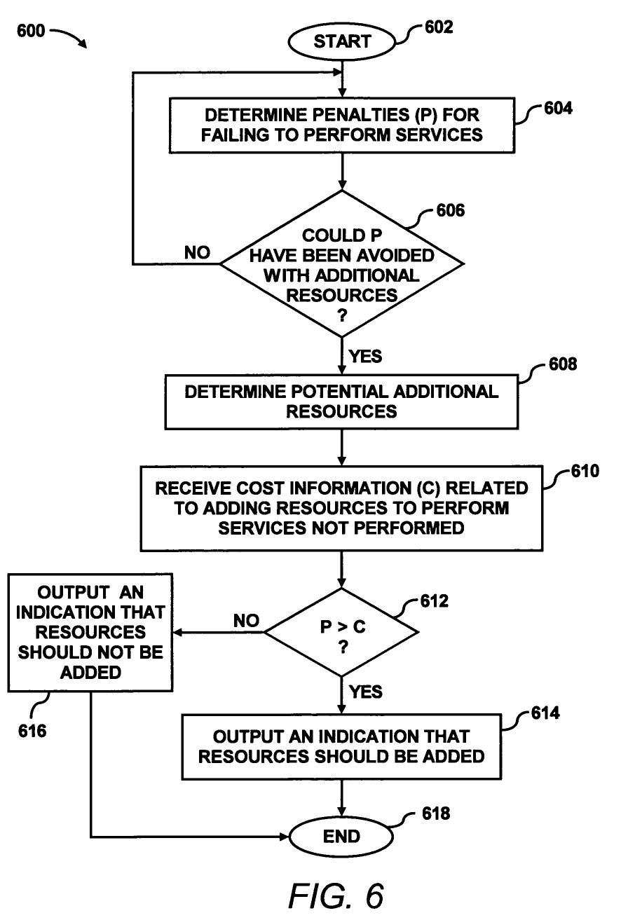

Reference is now made to FIG. 6, which is an exemplary flow diagram of an operational mode 600 of a method for decision-making to determine whether resources should be added, according to an embodiment. It is to be understood that the following description of the operational mode 600 is but one manner of a variety of different manners in which an embodiment of the invention may be practiced. It should also be apparent to those of ordinary skill in the art that the operational mode 600 represents a generalized illustration and that other steps may be added or existing steps may be removed, modified or rearranged without departing from the scope of the invention.

The description of the operational mode 600 is made with reference to the block diagrams 400 and 450 illustrated in FIGS. 4A and 4B, respectively, and thus makes reference to the elements cited therein. It should, however, be understood that the operational mode 600 is not limited to the elements set forth in the block diagrams 400 and 450. Instead, it should be understood that the operational mode 600 may be practiced by decision-making systems having different configurations than those set forth in the block diagrams 400 and 450.

The operational mode 600 may be initiated in response to a variety of stimuli at step 602. For example, a user may manually initiate the operational mode 600, the operational mode 600 may be initiated in response to a service request, etc. By way of example, a user may manually initiate the operational mode 600 to determine whether additional resources should be added.

Once initiated, the resource manager 360 may determine information related to the penalties (P) suffered by the service provider for failing to perform requested services 380, as indicated at step 604. A user may provide the penalty information or the penalty information may automatically be determined by the resource manager 360 when the service provider fails to perform the requested services 380. In one example, the resource manager 360 may be configured to track the costs associated with the penalties incurred for failing to perform the requested services 380. In this regard, the determination of the penalties incurred may be accumulated by the resource manager 360. In addition, the resource manager 360 may be configured to track which penalties resulted from intentionally foregoing performance of the requested services 380, for instance, as determined in the operational mode 500 and which penalties resulted from a lack of resources.

At step 606, the resource manager 360 may determine whether some or all of the penalties may have been avoided if additional resources were available to perform the requested services 380. For instance, the resource manager 360 may determine that the requested services 380 were not performed because of a lack of capacity to perform those services. If the resource manager 360 determines that the penalties were not based upon lack of capacity, for instance, the penalties were intentionally incurred due to the costs 340 exceeding the penalties, the resource manager 360 may determine that the penalties could not have been avoided with additional resources at step 606. If the resource manager 360 determines that the penalties could have been avoided with additional resources, the resource manager 360 may determine potential additional resources capable of performing the requested services 380 at step 608. By way of example, the resource manager 360 may determine that the requested services 380 could have been performed if an additional X number of computer systems were available to perform those services. In addition, the resource manager 360 may consider additional factors in determining the additional resources. For instance, the resource manager 360 may consider costs associated with installation and operation as well as costs associated with cooling the additional resources.

At step 610, the resource manager 360 may receive information pertaining to the costs (C) associated with the additional resources, for instance, computer systems, storage systems, disk drives, cooling systems, etc., to perform the requested services. The resource manager 360 may consider these costs as being marginal and not directly related to the performance of the operational mode 500. In addition, the resource manager 360 may evaluate a number of penalties and additional resource considerations in determining the cost information related to the addition of resources. This information may, for instance, be stored in the memory 420 and may be input by a user. The resource manager 360 may determine whether the penalties (P) exceed the costs (C) at step 612. If the resource manager 360 determines that the penalties (P) exceed the costs (C), the resource manager 360 may output an indication that additional resources should be purchased, as indicated at step 614. If, however, the resource manager 360 determines that the penalties (P) do not exceed the costs (C), the resource manager 360 may output an indication that additional resources should not be purchased, as indicated at step 616.

Following either of steps 614 or 616, the operational mode 600 may end as indicated at step 618. Step 618 may be equivalent to an idle mode as the operational mode 600 may be reactivated, for instance, when the resource manager 360 receives another request to determine whether resources should be added.

The operations set forth in the operational modes 500 and 600 may be contained as utilities, programs, or subprograms, in any desired computer accessible medium. In addition, the operational modes 500 and 600 may be embodied by computer programs, which may exist in a variety of forms both active and inactive. For example, the computer programs may exist as software programs comprised of program instructions in source code, object code, executable code or other formats. Any of the above may be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

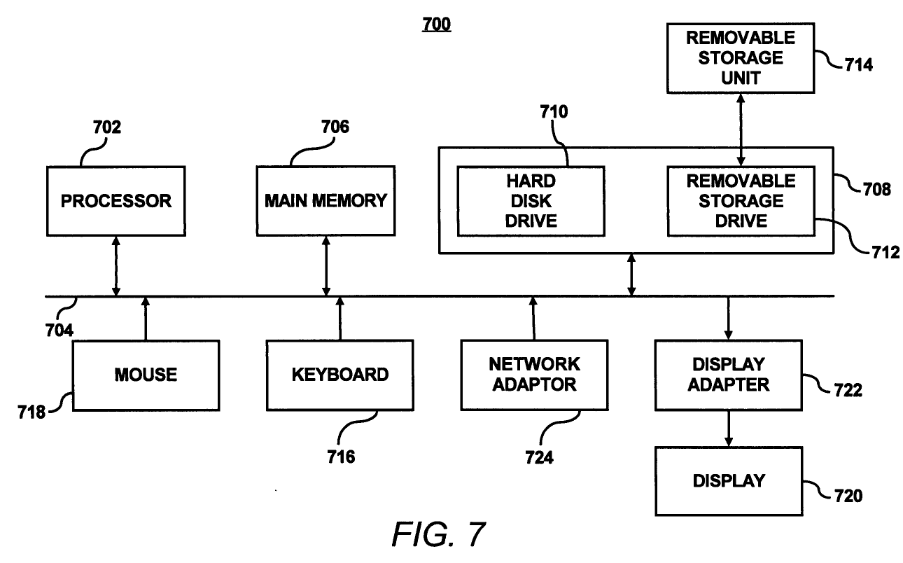

FIG. 7 illustrates a computer system 700, according to an embodiment of the invention. The computer system 700 may include, for example, the resource manager 360. In this respect, the computer system 700 may be used as a platform for executing one or more of the functions described hereinabove with respect to the various components of the decision-making system 410.

The computer system 700 includes one or more controllers, such as a processor 702. The processor 702 may be used to execute some or all of the steps described in the operational modes 500 and 600 described hereinabove. Commands and data from the processor 702 are communicated over a communication bus 704. The computer system 700 also includes a main memory 706, such as a random access memory (RAM), where the program code for, for instance, the resource manager 360, may be executed during runtime, and a secondary memory 708. The secondary memory 708 includes, for example, one or more hard disk drives 710 and/or a removable storage drive 712, representing a floppy diskette drive, a magnetic tape drive, a compact disk drive, etc., where a copy of the program code for the provisioning system may be stored.

The removable storage drive 712 reads from and/or writes to a removable storage unit 714, such as a floppy diskette, compact disk, magnetic tape, etc., in a well-known manner. User input and output devices may include a keyboard 716, a mouse 718, and a display 720. A display adaptor 722 may interface with the communication bus 704 and the display 720 and may receive display data from the processor 702 and convert the display data into display commands for the display 720. In addition, the processor 702 may communicate over a network, e.g., the Internet, LAN, etc., through a network adaptor 724.

It will be apparent to one of ordinary skill in the art that other known electronic components may be added or substituted in the computer system 700. In addition, the computer system 700 may include a system board or blade used in a rack in a data center, a conventional “white box” server or computing device, etc. Also, one or more of the components in FIG. 7 may be optional (e.g., user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A system for tracking costs, said system comprising:
a memory;
an application for monitoring costs associated with performing a computational service, said application being stored in the memory; and
a controller configured to receive cost information in machine-readable form from one or more input mechanisms, and wherein the controller is configured to execute the application to track the costs associated with performing the computational service.

2. The system according to claim 1, wherein the controller is configured to receive information pertaining to energy usage for at least one of operating resources to perform the computational service and cooling the resources to maintain the temperatures of the resources within predetermined ranges, wherein the controller is configured to receive per unit costs of energy supplied to the resources, and wherein the controller is configured to determine costs associated with the energy usage by the resources configured to perform the computational service.

3. The system according to claim 2, wherein the cost information comprises one or more of maintenance costs, electricity costs, cooling costs, security costs, depreciation costs, and administration costs.

4. The system according to claim 1, wherein the controller is configured to receive a penalty amount from a service level agreement, wherein the controller is configured to compare the costs with the penalty amount, and wherein the controller is configured to signal an alert with an output device when the costs at least one of reach the penalty amount and reach a predetermined amount near the penalty amount.

5. The system according to claim 1, wherein the controller is configured to display the costs on a display, and wherein the controller is configured to change the display in response to changes in the costs.

6. A method for tracking costs, said method comprising:
collecting one or more costs in machine-readable form associated with performing a service; and
tracking the one or more costs.

7. The method according to claim 6, wherein the one or more costs comprises costs associated with at least one of electrical demands and cooling requirements of resources configured to perform services, wherein the step of collecting one or more costs further comprises receiving electricity cost information, and wherein the step of tracking the one or more costs comprises calculating the costs of the electrical demands and the cooling requirements.

8. The method according to claim 6, further comprising:
receiving a penalty amount specified in a service level agreement associated with the service;
comparing the tracked one or more costs with the penalty amount; and
signaling an alert in response to the tracked one or more costs at least one of reaching the penalty amount and reaching a predetermined amount near the penalty amount.

9. The method according to claim 6, further comprising:
displaying the tracked one or more costs on a display; and
varying the displayed one or more costs in response to changes in the one or more costs.

10. A system for tracking costs, said system comprising:
means for collecting one or more costs in machine-readable form associated with performing a service; and
means for tracking the one or more costs.

11. The system according to claim 10, further comprising:
means for displaying the tracked one or more costs.

12. A computer readable storage medium on which is embedded one or more computer programs, said one or more computer programs implementing a method for tracking costs, said one or more computer programs comprising a set of instructions for:
collecting one or more costs in machine-readable form associated with performing a service; and
tracking the one or more costs.

13. The computer readable storage medium according to claim 12, said one or more computer programs further comprising a set of instructions for:
receiving electricity cost information; and
calculating the costs of the electrical demands and the cooling requirements.

14. The computer readable storage medium according to claim 12, said one or more computer programs further comprising a set of instructions for:
receiving a penalty amount specified in a service level agreement associated with the service;
comparing the tracked one or more costs with the penalty amount; and
signaling an alert in response to the tracked one or more costs at least one of reaching the penalty amount and reaching a predetermined amount near the penalty amount.

15. The computer readable storage medium according to claim 12, said one or more computer programs further comprising a set of instructions for:
displaying the tracked one or more costs on a display; and
varying the displayed one or more costs in response to changes in the one or more costs.

16. A system for making service performance decisions, said system comprising:
a resource manager configured to receive cost information in machine readable form related to performing a service and at least one of a payment amount for performing a requested service and a penalty amount for failing to perform the requested service, wherein the resource manager is configured to determine which of the cost information and one or both of the payment amount and the penalty amount is higher, and wherein the resource manager is configured to output a decision on whether to perform the service based on the determination.

17. The system according to claim 16, wherein the cost information comprises one or more of maintenance costs, electricity costs, cooling costs, security costs, depreciation costs, and administration costs.

18. The system according to claim 16, wherein the resource manager is configured to receive cost information from an operator of a service provider, and wherein the resource manager is configured to receive one or both of the payment amount and the penalty amount from a service level agreement.

19. The system according to claim 16, wherein the resource manager comprises at least one of a computer system, a controller, and software operating on a computing platform.

20. The system according to claim 16, wherein the resource manager is in communication with a resource device configured to perform the service, wherein the resource device is configured to communicate one or both of electrical demand and thermal output characteristics to the resource manager.

21. The system according to claim 20, further comprising:
an information storage device configured to communicate with the resource device and the resource manager, and
wherein the resource device is configured to communicate one or both of the electrical demand and the thermal output characteristics to the information storage device, said information storage device being configured to communicate the one or both of the electrical demand and the thermal output characteristics to the resource manager.

22. The system according to claim 16, wherein the resource manager is configured to output an indication to forgo performance of the service if the costs associated with performing the service exceeds one or both of the payment amount and the penalty amount and to output an indication to perform the service if the costs associated with performing the service falls below one or both of the payment amount and the penalty amount.

23. The system according to claim 16, wherein the resource manager is configured to determine which penalty amounts could have been avoided with additional resource devices, determine potential additional resources which could have been employed to avoid the penalty amounts, receive costs related to the potential additional resources, compare the costs related to the potential additional resources with the penalty amounts, and output an indication as to whether additional resources should be added based upon the difference between the costs related to the potential additional resources and the penalty amounts.

24. The system according to claim 23, wherein the resource manager is further configured to output an indication that additional resources should be added if the penalty amounts exceed the costs related to the potential additional resources and to output an indication that additional resources should not be added if the penalty amounts fall below the costs related to the potential additional resources.

25. A method for determining whether to perform a requested service, said method comprising:
receiving a service request;
determining costs associated with performing the requested service;
receiving amounts pertaining to at least one of a payment for performing the requested service and a penalty corresponding to failure to perform the requested service;
comparing the costs associated with performing the requested service with the at least one of the payment and the penalty amounts; and
determining whether to perform the requested service in response to the comparison of the costs and the at least one of the payment and the penalty amounts.

26. The method according to claim 25, wherein the step of determining whether to perform the requested service comprises determining to forgo performance of the requested service in response to the costs exceeding the amounts of at least one of the payment and the penalty and determining to perform the requested service in response to the costs falling below the amounts of at least one of the payment and the penalty.

27. The method according to claim 26, wherein the step of forgoing performance of the requested service comprises forgoing performance of the requested service when sufficient resources exist to perform the requested service.

28. The method according to claim 25, further comprising:
inputting the costs associated with performing the requested service into a decision-making system; and
inputting the amounts of at least one of the payment and penalty into the decision-making system, wherein the decision-making system is configured to perform the comparing step.

29. The method according to claim 28, wherein the costs include costs associated with at least one of electrical demands and thermal outputs of one or more resource devices configured to perform the requested service, the method further comprising:
sending the at least one of the electrical demands and the thermal outputs in machine-readable form to the decision-making system.

30. The method according to claim 29, wherein the sending step comprises an intermediate step of sending the at least one of the electrical demands and the thermal outputs through an information storage device.

31. The method according to claim 25, wherein the amounts pertaining to at least one of a payment for performing the requested service and a penalty corresponding to failure to perform the requested service are stipulated in a service level agreement, and wherein the step of receiving the amounts comprises receiving the amounts from the service level agreement.

32. A method for determining whether resources should be added, said method comprising:
determining penalties suffered for failing to perform one or more services;
determining whether one or more of the penalties could have been avoided with additional resources;
determining potential additional resources which could have been employed to avoid the one or more penalties;
receiving cost information related to adding the potential additional resources;
comparing the cost information with the one or more penalties; and
outputting an indication as to whether additional resources should be added in response to the comparison step.

33. The method according to claim 32, wherein the step of outputting an indication comprises outputting an indication that additional resources should be added in response to the one or more penalties exceeding the costs associated with adding the potential additional resources and outputting an indication that additional resources should not be added in response to the one or more penalties not exceeding the costs associated with adding the potential additional resources.

34. The method according to claim 32, wherein the step of determining whether one or more of the penalties could have been avoided with additional resources comprises determining whether one or more of the services were not performed due to costs associated with performing the one or more services exceeding the penalties for failing to perform the one or more services, and wherein the step of determining potential additional resources comprises determining potential additional resources that could have been employed to avoid the one or more penalties that were not due to the costs associated with performing the one or more services exceeding the penalties for failing to perform the one or more services.

35. A system for making service performance decisions, said system comprising:
means for receiving a service request;
means for determining costs associated with performing the requested service;
means for receiving amounts pertaining to at least one of a payment for performing the requested service and a penalty corresponding to failure to perform the requested service;
means for comparing the costs associated with performing the requested service with the at least one of the payment and the penalty amounts; and
means for determining whether to perform the requested service in response to the comparison of the costs and the at least one of the payment and the penalty amounts.

36. The system according to claim 35, further comprising:
means for inputting the costs associated with performing the requested service into a decision-making system; and
means for inputting the amounts of at least one of the payment and penalty into the decision-making system, wherein the decision-making system is configured to perform the comparing step.

37. The system according to claim 35, further comprising:
means for sending at least one of an electrical demand and a thermal output characteristic in machine-readable form from one or more resource devices to the means for determining whether to perform the requested service.

38. The system according to claim 37, wherein the means for sending comprises an information storage device.

39. The system according to claim 35, further comprising:
means for determining penalties suffered for failing to perform one or more services;
means for determining whether one or more of the penalties could have been avoided with additional resources;
means for determining potential additional resources which could have been employed to avoid the one or more penalties;
means for receiving cost information related to adding the potential additional resources;
means for comparing the cost information with the one or more penalties; and
means for outputting an indication as to whether additional resources should be added in response to the comparison step.

40. A computer readable storage medium on which is embedded one or more computer programs, said one or more computer programs implementing a method for determining whether to perform a requested service, said one or more computer programs comprising a set of instructions for:
determining costs associated with performing the requested service;
receiving amounts pertaining to at least one of a payment for performing the requested service and a penalty corresponding to failure to perform the requested service;
comparing the costs associated with performing the requested service with the at least one of the payment and the penalty amounts; and
determining whether to perform the requested service in response to the comparison of the costs and the at least one of the payment and the penalty amounts.

41. The computer readable storage medium according to claim 40, said one or more computer programs further comprising a set of instructions for:
determining to forgo performance of the requested service in response to the costs exceeding the amounts of at least one of the payment and the penalty and determining to perform the requested service in response to the costs falling below the amounts of at least one of the payment and the penalty.

42. The computer readable storage medium according to claim 40, said one or more computer programs further comprising a set of instructions for:
determining penalties suffered for failing to perform one or more services;
determining whether one or more of the penalties could have been avoided with additional resources;
determining potential additional resources which could have been employed to avoid the one or more penalties;
receiving cost information related to adding the potential additional resources;
comparing the cost information with the one or more penalties; and
outputting an indication as to whether additional resources should be added in response to the comparison step.

43. The computer readable storage medium according to claim 40, said one or more computer programs further comprising a set of instructions for:
outputting an indication that additional resources should be added in response to the one or more penalties exceeding the costs associated with adding the potential additional resources and outputting an indication that additional resources should not be added in response to the one or more penalties not exceeding the costs associated with adding the potential additional resources.
